(19) United States
(12) Patent Application Publication
(10) Pub. No.: US 2007/0188454 A1
(43) Pub. Date: Aug. 16, 2007

(54) Magnetic ratchet for input device roller

(75) Inventors: Timothy O'Sullivan, Bantry (IE); Marc Bidiville, Monte Carlo (MC)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/355,507

(22) Filed: Feb. 15, 2006

(51) Int. Cl. G09G 5/08

(52) U.S. Cl. 345/163

(57) ABSTRACT

A reduced power magnetic or electromagnetic ratchet for a roller on an input device. In one embodiment, opposing rings of permanent magnets are mounted in the roller, or are attached to the roller by a gearing arrangement. In another embodiment, a variable reluctance stepper motor is used

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates to a roller or wheel on an input device, such as a mouse. In particular, it relates to providing a magnetic ratchet or detent force for the user of the roller.

A roller is typically used on a mouse in addition to the primary input which comes from moving the mouse around on a ball protruding from the bottom of the mouse housing. Alternately, an optical sensor may be used instead of a ball. Other input devices, such as a track ball with the ball on top, a joystick, etc., will have a movable portion for providing the input. In addition to this movable portion, a roller may be added as well. The roller can be used for such functions as scrolling or zooming. The roller is operated by a user's finger, much like a dial on a radio.

There are a number of different designs for such rollers on a mouse or other device. Examples include Multipoint Technology Corporation U.S. Pat. No. 5,298,919, Microsoft U.S. Pat. No. 5,473,344, Apple Computer U.S. Pat. Nos. 5,313,230 and 5,095,303, Mouse Systems U.S. Pat. Nos. 5,530,455 and 5,446,481, Primax Electronics U.S. Pat. No. 5,808,568, and Logitech U.S. Pat. No. 6,157,369.

Force feedback has been used in different input devices, including mice. Examples of force feedback mechanisms can be found in a number of patents assigned to Immersion Corporation, such as U.S. Pat. No. 5,825,303, U.S. Pat. No. 5,734,373, U.S. Pat. No. 5,767,839, U.S. Pat. No. 5,721,566, U.S. Pat. No. 5,805,140, U.S. Pat. No. 5,691,898 and U.S. Pat. No. 5,828,197.

Immersion Corporation U.S. Pat. No. 6,128,006 describes force feedback on a mouse wheel (roller). The mechanism shown is a motor either directly connected to the axle of the mouse wheel, or a pulley drive coupled to the axle. A passive actuator such as a magnetic particle brake or a friction brake is discussed.

U.S. Pat. No. 6,128,006 also describes a number of different types of feedback. The feedback can be provided to simulate the ratchet effect currently provided by mechanical spring-type mechanisms in mouse wheels. The feedback can also be used to provide user feedback when a line is crossed on a document on a display. Similar feedback can be provided for the end of the page or the end of a document. The patent also describes providing an amount of feedback which is related to the size of the document. The patent also describes that when the wheel is used for a cursor, feedback can be provided on graphic items that the cursor passes over. In addition, a roller can vibrate to indicate an alert, such as an email message or an error in a program.

Culver (Immersion) U.S. Pat. No. 6,300,938 describes an electromagnetic brake that can be used on a cylindrical roller. This can be used for various force feedback effects, including detents. Logitech U.S. Pat. No. 6,809,727 describes various uses of magnets, solenoids and electromagnets for force feedback in a roller for various effects, including a detent or ratcheting effect. In particular an electromagnetic brake is described.

The use of magnets or magnetism for detecting x-y movement, such as by using a magnetic ball in a mouse, is shown in U.S. Pat. No. 5,583,541, U.S. Pat. No. 5,696,537 and U.S. Pat. No. 6,809,722. Other patents mentioning magnetic sensors for input devices include U.S. Pat. No. 6,624,808, U.S. Pat. No. 6,483,294 and Logitech U.S. Pat. No. 6,400,356.

A disadvantage of force feedback is the power required to provide the force which is felt by the user. This is particularly problematic for a cordless mouse or other device which relies on batteries, or on a device which is powered off of the limited power from the universal serial bus (USB)

### BRIEF SUMMARY OF THE INVENTION

The present invention provides a reduced power magnetic or electromagnetic ratchet for a roller on an input device. In one embodiment, opposing rings of permanent magnets are mounted in the roller, or are attached to the roller by a gearing arrangement. This eliminates the power requirement of electromagnets.

In another embodiment, a variable reluctance stepper motor is used By varying the power and timing of applying power to the stepper motor, one can control both the amount of ratchet force, and the number of ratchets per revolution.

### BRIEF DESCRIPTION OF THE DRAWINGS

FIG. 1 is a block diagram of the electronics of the tactile feedback according to one embodiment of the present invention.

FIG. 2 is a block diagram of the tactile feedback software according to an embodiment of the invention.

FIG. 3A is a cut-away side view of an embodiment of a solid state permanent magnet ratchet.

FIG. 3B is a side view of the solid state permanent magnet ratchet mechanism shown in FIG. 3A and shows first and second flux traps disposed on either side of the mechanism.

FIG. 4 is a cut-away side view of an embodiment of a ratchet using a variable reluctance stepper motor.

FIG. 5 is a diagram of an embodiment of a ratchet according to FIGS. 3-4, with a planetary gear attachment to a roller.

FIG. 6 is a simplified schematic of a ratchet device that may be coupled to a roller or may form a portion of a roller.

### DETAILED DESCRIPTION OF THE INVENTION

System Overview

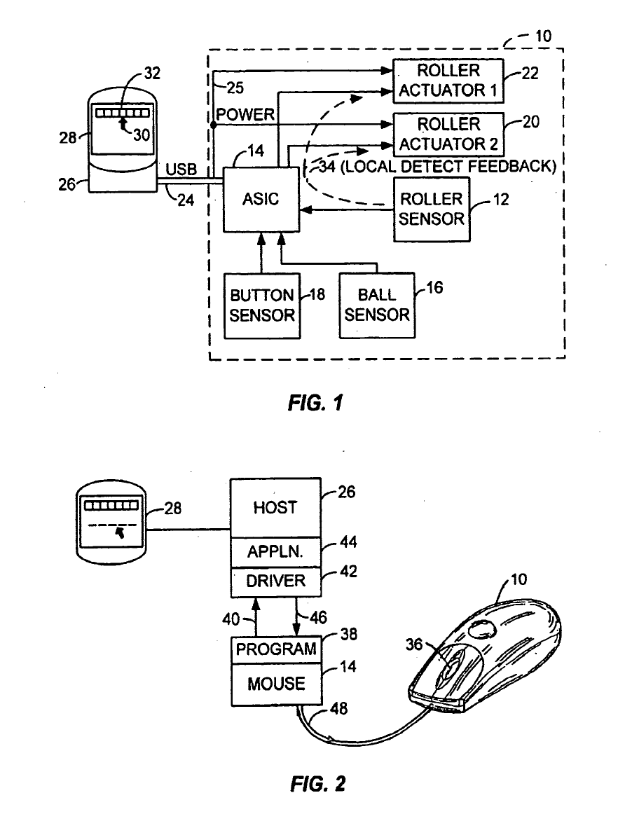

FIG. 1 is a block diagram of the electronic system for tactile feedback according to an embodiment of the invention. Shown is a mouse 10 which has a roller sensor 12 for detecting the movement of a roller or wheel. The sensor signals are provided to a processing circuit in an ASIC 14. ASIC 14 also receives signals from a mouse sensor 16 and button sensors 18. Mouse sensor 16 provides detector signals from two encoder rollers on a mouse ball, or alternately an optical signal on an optical mouse.

ASIC 14 also controls two roller actuators 20 and 22 which provide a ratcheting function on the mouse roller or wheel, as will be described below. The actuators which need power receive their power on lines 25 from a USB 24. Thus, the amount of power used by the actuators needs to be minimized. The sensor signals received by ASIC 14 are put into a packet format and transmitted over USB 24 to a host computer 26 for controlling a display 28. Host 26 may provide feedback signals back to ASIC 14 in response to the position of a cursor 30 on display 20, such as having less ratchets in a long document.

In one mode, instead of a sensor signal being sent to the host, and feedback signals being received back, the host can be bypassed to provide a detent feel to rotation of the mouse roller. In prior rollers, this has been done mechanically through the use of a spring mechanism mounted in the mouse. In the present invention, this can be provided through the tactile feedback mechanism using the detent local feedback path indicated by the dotted line 34 in FIG. 1. The timing of detents or ratchets can be controlled by turning off the stepping motor periodically. A roller sensor signal from roller sensor 12 indicates that the roller has been turned a predetermined amount, a signal can be provided to the appropriate roller actuator of roller actuators 20 and 22. The use of such local feedback eliminates the need to send data over the USB or over a wireless link, removing bandwidth concerns and also providing more instantaneous feedback.

FIG. 2 is a block diagram of the software used in an embodiment of the present invention. Shown is a mouse 10 with a roller 36. Inside mouse 10 is a processor or ASIC 14 including a program 38 for controlling the mouse. Sensor signals 40 are provided to host computer 26, in particular to a driver 42 in the host. The driver in turn can provide signals to an application program 44, which controls the particular graphics on a display 28. Upon certain conditions, such as scrolling up a line or page, a tactile feedback signal can be provided from application program 44 to driver 42 and back to ASIC 14 as control commands 46. In response to these, program 38 provides signals 48 to the stepping motor in mouse 10.

Permanent Magnet Ratchet

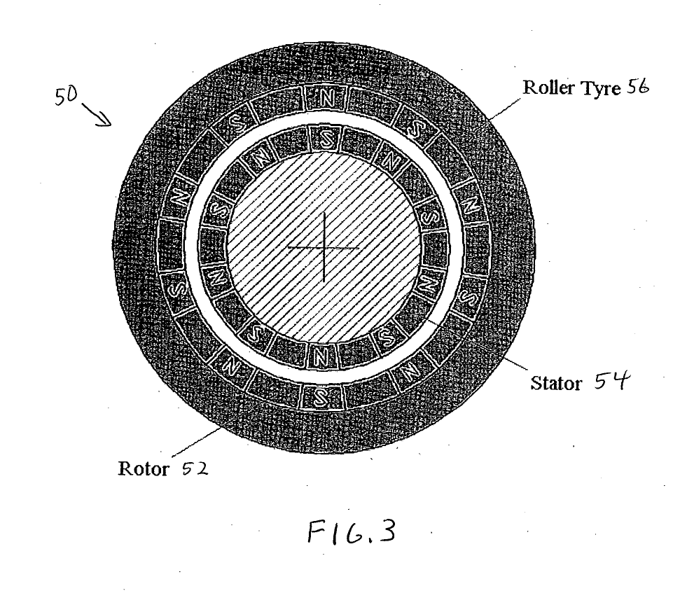

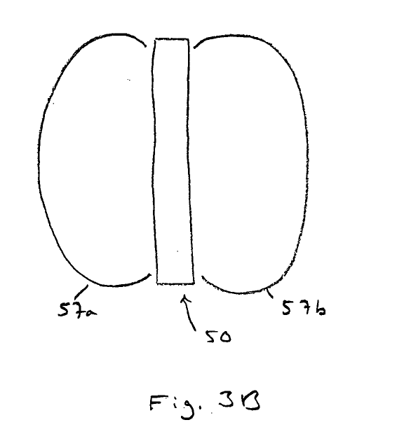

FIG. 3A illustrates and embodiment of a permanent magnet ratchet mechanism 50. The mechanism consists of two ferromagnetic cylinders, one forming a rotor 52 and the other forming a stator 54. They are magnetized in the pattern shown in FIG. 3A. They are held apart with a small air gap. The inner cylinder is held stationary while the outer cylinder 52 is allowed to rotate. As shown, the outer cylinder, rotor 52, is surrounded by a tire 56 forming the outside of the wheel which is engaged by the user's finger.

As the user begins to rotate the roller, the magnetic torque increases until it reaches a maximum, when the poles are directly opposite each other. Just beyond this opposite position the force will suddenly reverse, leading to the roller being rapidly drawn to the next stable position. This provides a smooth ratchet feel to the user with the absence of noise and wear.

The permanent magnet arrangement of FIG. 3A can be implemented in a number of ways. The roller 56 and rotor 52 can be mounted on an axle with spokes or a solid connection to the axle on one side. The stator can be supported on a fixed support on the other side of the roller, with the stator extending into the interior of the roller/rotor, and the axle passing though an air gap in the center of the stator. Alternately, the stator could be mounted to the side of a separate roller, such as in the arrangement shown in FIG. 5, below. The rotor is attached to a gearing mechanism inside the roller, which can be constructed with the desired gearing reduction.

FIG. 3B is a side view of permanent magnet ratchet mechanism 50 and shows first and second flux traps 57a and 57b, respectively, disposed on either side of mechanism 50. The flux traps may be ferromagnetic and may be substantially shaped like magnetic field lines that emanate from the magnets of the mechanism. The flux traps are configured to limit the amount of magnetic flux that passes the traps, and thereby limits the magnetic flux that reaches other regions of the control device, such as regions that include integrated circuits and the like.

Stepper Motor Ratchet

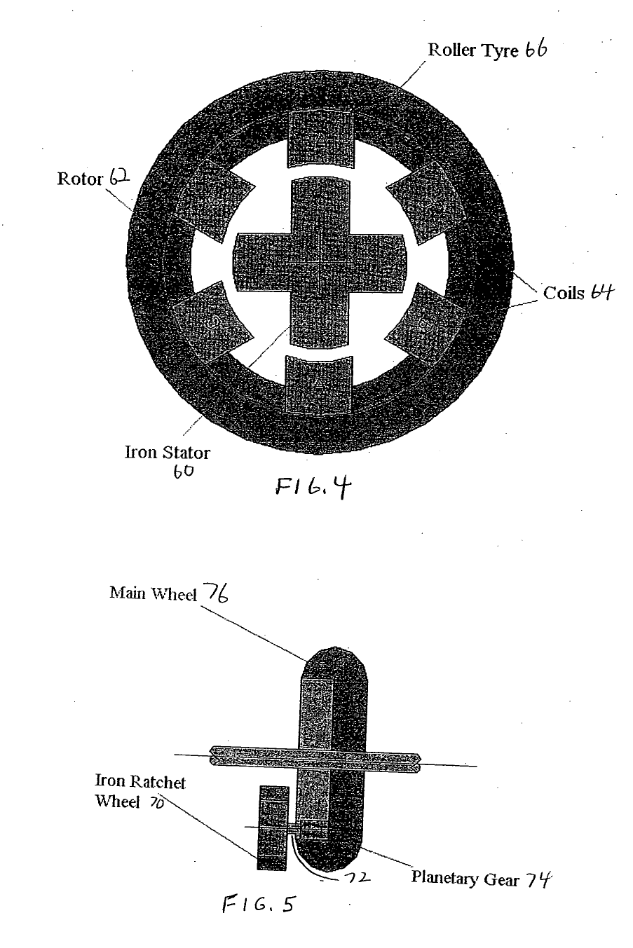

FIG. 4 illustrates a stepper motor embodiment of the present invention. A central iron stator 60 is surrounded by a rotor 62 having a number of coils 64. The stator and rotor can have more teeth than are shown in this diagram. A rubber tire 66 is mounted on the rotor, to form the wheel which can be moved by a users fingers. The stepper motor can be mounted directly inside the roller as shown in FIG. 4, or can be mounted as shown in FIG. 5. Examples of variable reluctance stepper motors are described in U.S. Pat. No. 4,794,286, U.S. Pat. No. 4,286,180 and U.S. Pat. No. 4,029,997.

By applying the right amount of current to the coils in sequence, the impression of ratchets can be created, by having the motor trying to turn against the movement of the user's fingers at the ratchet positions. The amount of ratchet force can be varied by varying the amount of current applied. The number of ratchets can be varied by skipping some teeth, or coils, in the stepper motor. These variations can be done on the fly. In addition, inertial feedback can be provided, such as by having the motor push slightly back against the user's fingers to give a heavy feel, such as for a very long document. Alternately, the motor can move with the user's finger to give a gliding feel. This gives a simulated inertia, to provide a power steering effect. In addition, the motor could move the wheel on its own after the user gives it an initial push, to cause continuous scrolling. For example, such a continuous scrolling could be activated when the user suddenly releases while moving the wheel quickly. Alternately, if the user stops first, then releases the wheel, continuous scrolling will not be activated.

The wheel of FIG. 4 can also be used for other force feedback to the user. Vibration can be enabled by alternating the voltage applied to the phases of the motor, causing the wheel to shake. In addition, the feedback to the wheel can be used for notification purposes, such as for an incoming email. This could be combined with light being emitted, either with an LED on a mouse or other input device, or by use of a transparent material for the roller which allows light to shine through. The light could be generated by an LED or mechanically, through the movement of the wheel. Such notification can be done when the user does not have a hand on the mouse, with the wheel spinning and lighting up, for instance. A pair of flux traps may be disposed on either side of the wheel as described above and as shown in FIG. 3B.

FIG. 5 illustrates an embodiment where a rotor 70 is coupled by an axle 72 to a planetary gear 74 inside a wheel 76. The rotor could be the rotor of FIG. 3A or FIG. 4.

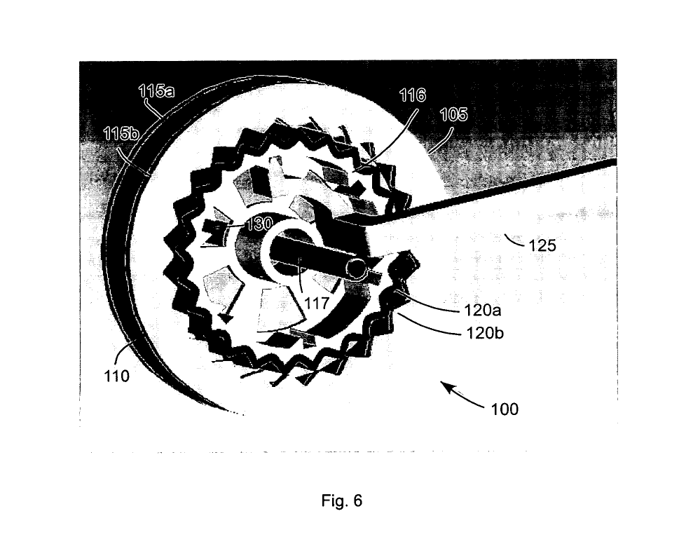

FIG. 6 is a simplified schematic of a ratchet device 100 that may be coupled to a roller or may form a portion of a roller. The roller includes an outer ring 105 that includes a magnet 110 disposed between ferromagnetic plates 115a and 115b, and includes an inner ring 116 that may also be ferromagnetic. The rings may be coupled to an axle 117 that rotationally supports the rings. While the specific device for coupling the rings to the axle is not shown, such coupling devices will be well understood by those of skill in the art.

The inner ring and the outer ring include sets of teeth 120a and 120b, respectively. The outer ring or alternatively the inner ring may be coupled to a portion of the roller that is configured to be pushed by a user to rotate the roller. As the roller is rotated the sets of teeth pass each other and magnetically interact to provide ratcheting.

The ratchet device may further include a locking device 125 (e.g., a locking bar) that is configured to engage one or more slots 130 to prevent the inner ring from rotating as the outer ring is rotated. If the locking device is engaged in one of the slots, the inner ring will be held substantially stationary as the outer ring is rotate and the teeth will magnetically interact to provide the ratcheting. The locking device may be disengaged from the slots by a variety of devices, such as a DC motor, a solenoid, a manual actuator that is manually controlled by a user or the like. If the locking device is disengaged from the inner ring, the teeth of the inner ring are configured to magnetically interact with the teeth of the outer ring such that the inner ring will rotate with the outer ring as the outer ring is rotated. As the inner ring and outer ring are configured to rotate together with the locking device dis-engaged, no ratcheting is applied to the roller and the other ring will rotate substantially smoothly in a smooth roller mode. A pair of flux traps may be disposed on either side of the ratchet device as described above and as shown in FIG. 3B.

As will be understood by those of skill in the art, the present invention may be embodied in other specific forms without departing from the essential characteristics thereof. For example, multiple gear reductions could be provided between a permanent magnet or stepper motor and a wheel. Other configurations could be used to connect the rotor to the wheel. The stator could be connected to the wheel in the arrangement of FIG. 5, instead of the rotor. Additionally, a sideways force could be generated for wheels that tilt sideways, to give a detent or other force feedback during horizontal scrolling. Accordingly, the foregoing description is intended to be illustrative, but not limiting, of the scope of the invention which is set forth in the following claims.

What is claimed is:

1. A user input device for interfacing with a host computer, comprising:
a rotatable wheel mounted in said input device, said wheel being rotatable by a digit of said user;
a wheel sensor mounted in said input device and providing a wheel signal to said host computer indicating a rotary position of said wheel; and
a permanent magnet coupled to said rotatable wheel and operative to provide a ratchet force to said rotatable wheel.

2. The device of claim 1 wherein said permanent magnet is mounted inside said wheel.

3. The device in claim 1 wherein said permanent magnet is mounted outside said wheel, and further comprising a gear inside said wheel coupled to said permanent magnet.

4. The device of claim 1 wherein said permanent magnet comprises a ferromagnetic stator cylinder mounted inside a ferromagnetic rotor, each of said stator and rotor having alternating magnetic poles.

5. The device of claim 4 wherein said rotor is coupled to said wheel.

6. The device of claim 1 further comprising at least one flux trap disposed adjacent to a side of said wheel.

7. A user input device for interfacing with a host computer, comprising:
a rotatable wheel mounted in said input device, said wheel being rotatable by a finger of a user;
a wheel sensor mounted in said input device and providing a wheel signal to said host computer indicating a rotary position of said wheel; and
a variable reluctance stepper motor coupled to said rotatable wheel and operative to provide a ratchet force to said rotatable wheel.

8. The device of claim 7 wherein said variable reluctance stepper motor is mounted inside said wheel.

9. The device in claim 7 wherein said variable reluctance stepper motor is mounted outside said wheel, and further comprising a gear inside said wheel coupled to said stepper motor.

10. The device of claim 7 wherein said stepper motor comprises an iron stator encircled by a rotor with coils, said rotor being coupled to said wheel.

11. The device of claim 7 further comprising at least one flux trap disposed adjacent to a side of said wheel.

12. A user input device for interfacing with a host computer, comprising:
a rotatable wheel mounted in said input device, said wheel being rotatable by a finger of a user;
a wheel sensor mounted in said input device and providing a wheel signal to said host computer indicating a rotary position of said wheel; and
first and second magnetic wheel coupled to said wheel and includes sets of opposing teeth that are configured to magnetically interact as the wheel is rotated to provide ratcheting.

13. The device of claim 12 further comprising a locking bar configured to lock the second wheel from rotating as the first wheel is rotated, and configured to be retraced wherein the second wheel is configured to rotate with the first wheel as the first wheel is rotated.
